(19) United States
(12) Patent Application Publication
(10) Pub. No.: US 2012/0252589 A1
(43) Pub. Date: Oct. 4, 2012

(54) CONSTANT VELOCITY JOINT

(75) Inventors: Tsutomu Kawakatsu, Utsunomiya-shi (JP); Takeshi Kayano, Haga-gun (JP); Atsushi Nagaoka, Mooka-shi (JP)

(73) Assignee: HONDA MOTOR CO., LTD., Tokyo (JP)

(21) Appl. No.: 13/515,304

(22) PCT Filed: Dec. 8, 2010
(86) PCT No.: PCT/JP2010/071968

§ 371 Date: Jun. 12, 2012

(30) Foreign Application Priority Data
Dec. 15, 2009 (JP) 2009-283929
Dec. 15, 2009 (JP) 2009-283935

(51) Int. Cl. F16D 3/205

(52) U.S. Cl. 464/111

(57) ABSTRACT

A constant velocity joint includes a cylindrical outer cup which has three guide grooves on an inner wall surface thereof, and an inner member which is housed inside of the aforementioned outer cup and has three trunnions. The aforementioned guide grooves are formed to have a large width and to be close to the center of the aforementioned outer cup, and the aforementioned trunnions are formed to have a large width corresponding to the aforementioned guide grooves. Further, annular rollers are mounted on the periphery of the trunnions, and the periphery surfaces of the aforementioned rollers contact rolling surfaces of the aforementioned guide grooves.

### TECHNICAL FIELD

The present invention relates to a constant velocity joint for joining one transmission shaft to another transmission shaft, and for transmitting drive power through the transmission shafts in a drive power transmitting mechanism of an automobile, for example.

### BACKGROUND ART

The present applicant has proposed a constant velocity joint in which a first shaft, which makes up one transmission shaft, and a second shaft, which makes up another transmission shaft, are joined to each other. The constant velocity joint transmits rotational power through the first and second shafts to axles in a drive power transmitting mechanism of an automobile. As disclosed in Japanese Patent No. 4068824, the constant velocity joint has a tubular outer joint member mounted on one end of the first shaft, an inner joint member fitted over the second shaft and which is housed in the outer joint member, and rotors that are mounted rotatably on respective trunnions of the inner joint member. When rotational power from the first shaft is transmitted through the outer joint member and the inner joint member to the second shaft, the first shaft and the second shaft rotate in unison with each other, and the inner joint member is displaced along an axial direction of the outer joint member.

### SUMMARY OF INVENTION

It is a general object of the present invention to provide a constant velocity joint which is reduced in size and weight.

According to the present invention, there is provided a constant velocity joint comprising a tubular outer member, which has a plurality of guide grooves defined in an inner circumferential surface thereof, the guide grooves being spaced from each other and extending in an axial direction, the outer member being coupled to a first transmission shaft, and an inner member, which is inserted in the outer member and coupled to a second transmission shaft, wherein:

the guide grooves of the outer member have ceilings, and rolling portions provided as flat surfaces substantially perpendicular to the ceilings, the rolling portions being held in abutment against rotors mounted on the inner member, the guide grooves being recessed radially outward with respect to the inner circumferential surface;

the inner member has a plurality of trunnions inserted respectively in the guide grooves, the rotors being rotatably mounted on respective outer circumferential surfaces of the trunnions; and

each of the trunnions has spherical surfaces that are arcuate in cross section, and which are fitted in a holder with one of the rotors being rotatably held thereon, and a set of flat surfaces lying perpendicular to an axial direction of a joint hole to which the second transmission shaft is coupled.

According to the present invention, each of the trunnions includes the spherical surfaces that are arcuate in cross section, and which are fitted in the holder with one of the rotors being rotatably held thereon, and the set of flat surfaces lying perpendicular to the axial direction of the joint hole to which the second transmission shaft is coupled.

Therefore, the inner member may be smaller in thickness than the constant velocity joint according to the background art, thereby making it possible to reduce the weight of the constant velocity joint including the inner member.

### BRIEF DESCRIPTION OF DRAWINGS

FIG. 1 is a vertical cross-sectional view of a constant velocity joint according to an embodiment of the present invention;

FIG. 2 is an enlarged cross-sectional view of the constant velocity joint shown in FIG. 1;

FIG. 3 is a cross-sectional view taken along line III-III of FIG. 1;

FIG. 4 is an enlarged cross-sectional view showing the shape of a constant velocity joint according to the background art, in comparison with the constant velocity joint shown in FIG. 2;

FIG. 5 is a perspective view of an inner member of the constant velocity joint shown in FIG. 1; and

FIG. 6 is an enlarged cross-sectional view of a constant velocity joint according to a modification.

### DESCRIPTION OF EMBODIMENTS

A constant velocity joint according to a preferred embodiment of the present invention will be described in detail below with reference to the accompanying drawings.

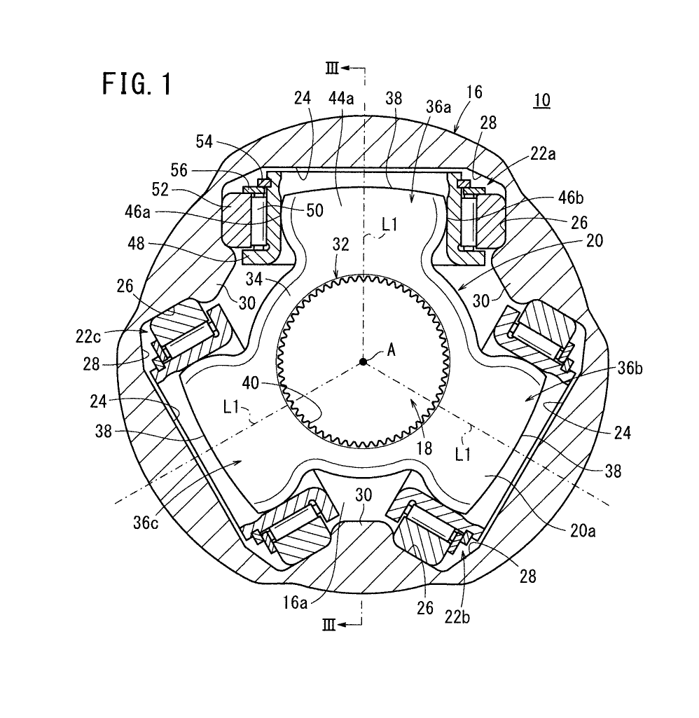

In FIG. 1, reference numeral 10 designates a constant velocity joint according to an embodiment of the present invention.

As shown in FIGS. 1 through 3, the constant velocity joint 10 includes a tubular outer cup (outer member) 16 integrally coupled to one end of a first shaft 12, which makes up one transmission shaft, the outer cup 16 having an opening 14 therein, and an inner member 20 fixed to one end of a second shaft 18, which makes up another transmission shaft, and which is housed in a hole 16a defined in the outer cup 16.

The outer cup 16 has three guide grooves 22a through 22c defined in an inner wall surface thereof and extending axially, the guide grooves 22a through 22c being angularly spaced from each other by roughly 120 degrees about the axis of the outer cup 16. Each of the guide grooves 22a through 22c has a flat ceiling 24, rolling surfaces (rolling portions) 26 defined by flat surfaces, which lie substantially perpendicular to the ceiling 24 and are held in contact with the outer circumferential surface of a roller 52, to be descried later, and slanted surfaces 28 that join the ceiling 24 and the rolling surfaces 26 to each other.

The ceiling 24 extends substantially perpendicular to a central line (axial line) L1, which extends from the center A of the outer cup 16 through the transverse center of each of the guide grooves 22a through 22c. The rolling surfaces 26 lie substantially parallel to the central line L1. The slanted surfaces 28 are slightly slanted from opposite ends of the ceiling 24 toward the center A of the outer cup 16. The central lines L1 of the outer cup 16 are aligned with the axial lines of trunnions 36a through 36c of the inner member 20, which is housed in the outer cup 16.

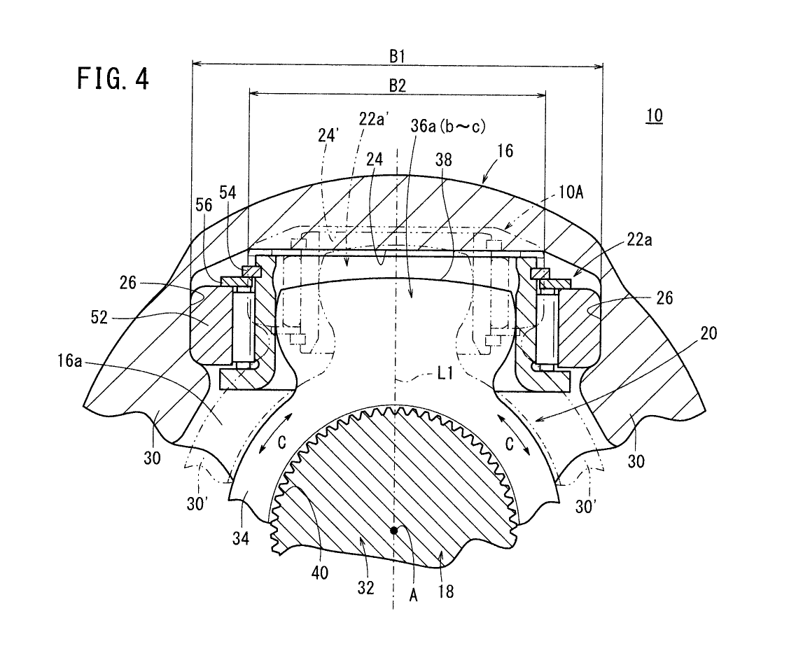

As shown in FIG. 4, the guide grooves 22a through 22c have a widthwise dimension B1 perpendicular to the central line L1 of the outer cup 16, which is greater than the widthwise dimension B2 of a guide groove 22a′ (22b′, 22c′) of a constant velocity joint 10A (indicated by the two-dot-and-dash lines shown in FIG. 4) according to the background art. The slanted surfaces 28, which are joined to the ends of the ceiling 24, include portions that are joined to the rolling surfaces 26 at positions near the outer circumferential surface of the outer cup 16.

The guide grooves 22a through 22c, which include the respective ceilings 24, are disposed at positions closer (radially inward) to the center A of the outer cup 16 than the guide groove 22a′ (22b′, 22c′) of the constant velocity joint 10A according to the background art.

The guide grooves 22a through 22c are thus disposed such that the rolling surfaces 26, which are located on transverse outermost sides of two adjacent guide grooves 22a, 22b, guide grooves 22b, 22c, and guide grooves 22c, 22a, are closer to each other as compared with the constant velocity joint 10A according to the background art. Further, as shown in FIG. 1, radially inward bulging portions are provided between two adjacent ones of the guide grooves 22a through 22c of the outer cup 16.

As shown in FIG. 4, the bulging portions 30 are narrower in the circumferential direction (in the direction indicated by the arrows C in FIG. 4) than bulging portions 30′ of the constant velocity joint 10A according to the background art. Therefore, the mass of the outer cup 16 is reduced owing to the reduction in size of the bulging portions 30.

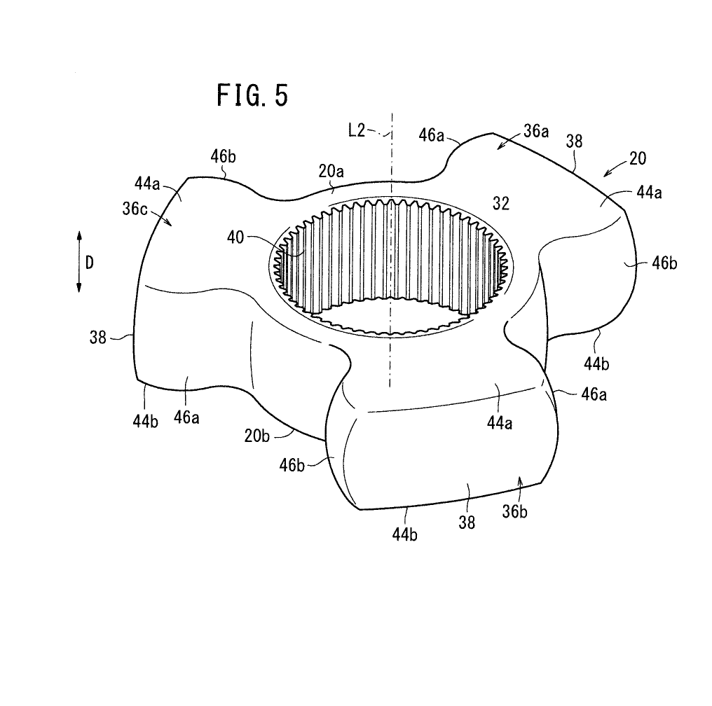

As shown in FIGS. 1 through 5, the inner member 20 includes a ring-shaped spider boss 34 having a penetrating shaft hole 32 defined centrally therein, and three trunnions 36a through 36c disposed on the outer circumferential surface of the spider boss 34 and projecting radially outward toward the respective guide grooves 22a through 22c. The trunnions 36a through 36c are angularly spaced from each other by roughly 120 degrees about the axis of the inner member 20. The trunnions 36a through 36c have respective curved portions 38, each of the curved portions 38 having an arcuate cross section of a prescribed curvature, provided on the respective outer circumferential surfaces thereof. Spline grooves 40, which extend axially (in the direction indicated by the arrow D in FIG. 5), are defined in the inner circumferential surface of the shaft hole (joint hole) 32. The second shaft 18 has spline keys 42 fitted respectively into the spline grooves 40.

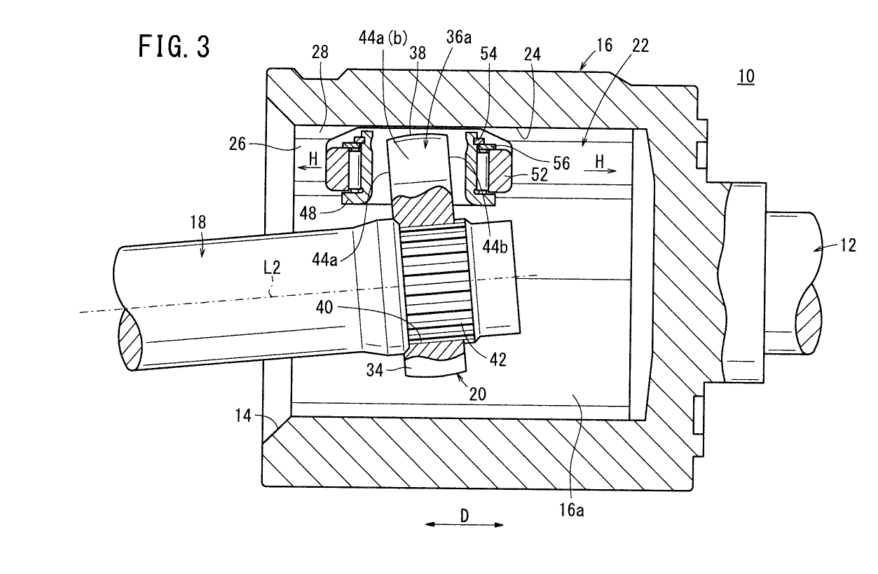

As shown in FIGS. 3 and 5, the inner member 20 is formed with a prescribed thickness along the axis of the shaft hole 32 (in the direction indicated by the arrow D), and has one end surface (flat surface) 20a and another end surface (flat surface) 20b, which are arranged perpendicularly to the axis L2. The end surface 20a and the end surface 20b are joined by gradual curved surfaces to the outer circumferential surface of the spider boss 34.

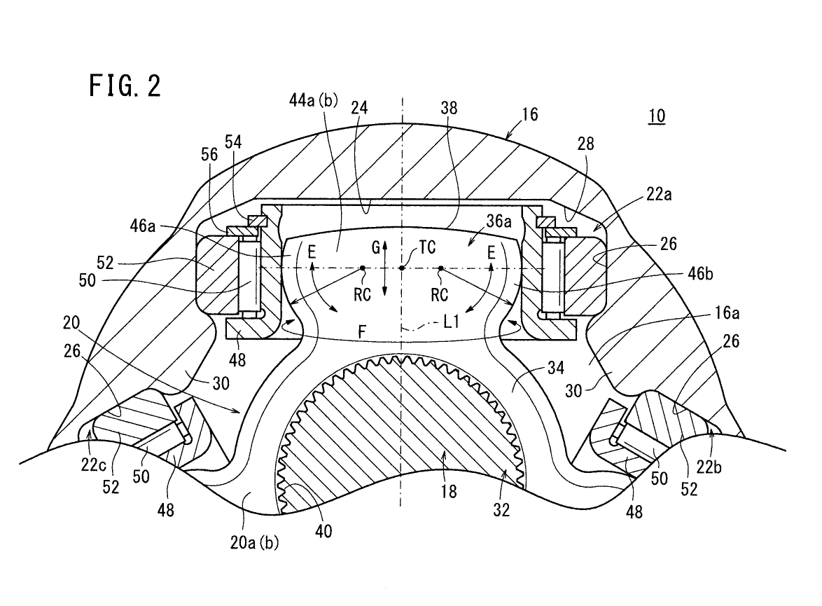

Each of the trunnions 36a through 36c has a set of flat surfaces 44a, 44b extending perpendicularly to the axis of the shaft hole 32 and lying flush with the respective end surfaces 20a, 20b of the spider boss 34, together with a set of spherical surfaces 46a, 46b on outer sides thereof, which lie substantially perpendicular to the flat surfaces 44a, 44b. Each of the spherical surfaces 46a, 46b are arcuate in cross section. As shown in FIG. 2, each of the spherical surfaces 46a, 46b has a center RC of curvature, which is positionally offset a prescribed distance from the center TC of the trunnions 36a through 36c toward the spherical surfaces 46a, 46b.

Ring-shaped holders 48 are fitted over the respective trunnions 36a through 36c. The ring-shaped holders 48 have respective inner circumferential surfaces, each having a flat cross section, which are held in sliding contact with the spherical surfaces 46a, 46b of the trunnions 36a through 36c, and out of contact with the flat surfaces 44a, 44b (see FIG. 3). In other words, the trunnions 36a through 36c are slidable along the axial direction of the holders 48, and are tiltable through a prescribed angle with respect to the holders 48.

The trunnions 36a through 36c are widely formed in directions perpendicular to the axial lines L1 in association with the respective guide grooves 22a through 22c of the outer cup 16, and are displaced radially inward so as to be closer to the spider boss 34 than the inner member of the constant velocity joint 10A according to the background art (see FIG. 4).

More specifically, the distance by which the trunnions 36a through 36c are spaced from the spider boss 34 is smaller than in the constant velocity joint 10A according to the background art, and the trunnions 36a through 36c are positioned closer to the spider boss 34 (radially inward) and are wider in the widthwise direction.

The trunnions 36a through 36c are angularly movable through prescribed angles in directions indicated by the arrows E with respect to inner circumferential surfaces of the holders 48. The trunnions 36a through 36c are also angularly movable in a circumferential direction (the direction indicated by the arrow F in FIG. 2) about the axial directions L1 of the trunnions 36a through 36c. The trunnions 36a through 36c are displaceable in a vertical direction (the direction indicated by the arrow G in FIG. 2) with respect to inner circumferential surfaces of the holders 48.

Ring-shaped rollers (rotors) 52 are fitted over the outer circumferential surfaces of the holders 48 with needle bearings 50 interposed therebetween. The needle bearings 50 and the rollers 52 are held in position by washers 56 and circlips 54, which are fitted in annular grooves defined in the holders 48. Alternatively, the needle bearings 50 and the rollers 52 can be held in position on the holders 48 only by the circlips 54, and the washers 56 may be dispensed with.

The constant velocity joint 10 according to the embodiment of the present invention is basically constructed as described above. Operations and advantages of the constant velocity joint 10 will be described below.

When the first shaft 12, which functions as one transmission shaft, rotates about its axis, rotational power of the first shaft 12 is transmitted through the outer cup 16 to the inner member 20, thereby rotating the second shaft 18 in a given direction. More specifically, rotational power of the outer cup 16 is transmitted through the rollers 52 that ride in the guide grooves 22a through 22c and the needle bearings 50, and then the rotational power is transmitted to the trunnions 36a through 36c through the spherical surfaces 46a, 46b, which are held in contact with the inner circumferential surfaces of the holders 48. Accordingly, the second shaft 18, which is fitted in the trunnions 36a through 36c, is rotated about its axis.

If the second shaft 18 is tilted by a certain angle with respect to the outer cup 16, which includes the first shaft 12, the trunnions 36a through 36c are slidingly displaced about centers TC thereof in the direction indicated by the arrow E, while the spherical surfaces 46a, 46b of the trunnions 36a through 36c are held in contact with the inner circumferential surfaces of the holders 48, as shown in FIG. 2.

The trunnions 36a through 36c also are displaced along a direction substantially perpendicular to the axial lines L1, i.e., in a longitudinal direction (the direction indicated by the arrows H in FIG. 3) while the rollers 52 slide along the guide grooves 22a through 22c (see FIG. 3). Therefore, rotary motion of the first shaft 12 is smoothly transmitted to the second shaft 18 without being affected by the angle (joint angle) at which the second shaft 18 is tilted with respect to the outer cup 16.

According to the present embodiment, as described above, the trunnions 36a through 36c of the inner member 20 include the spherical surfaces 46a, 46b, which are arcuate in cross section. Centers of curvature of the spherical surfaces 46a, 46b are positionally offset from the centers TC of the trunnions 36a through 36c, which are positioned on central lines L1 that pass through the center A of the outer cup 16 and the centers of the guide grooves 22a through 22c, as compared with the constant velocity joint 10A according to the background art. Therefore, the trunnions 36a through 36c are wide in directions perpendicular to the central lines L1, and the guide grooves 22a through 22c, in which the trunnions 36a through 36c are inserted, also are wide. As a result, the material making up the outer cup 16 is reduced between adjacent ones of the guide grooves 22a through 22c, thereby making it possible to reduce the weight of the outer cup 16.

The bulging portions 30, which are disposed between adjacent ones of the guide grooves 22a through 22c, are reduced in size, thereby reducing the material of the outer cup 16, and hence making it possible to reduce the weight of the outer cup 16.

Insofar as the width of the trunnions 36a through 36c is increased, the trunnions 36a through 36c can be reliably and firmly joined to the spider boss 34. Therefore, the inner member 20, which includes the trunnions 36a through 36c, is increased in rigidity. Furthermore, the inner member 20, which includes the trunnions 36a through 36c, is of a flat shape having the end surfaces 20a, 20b, which lie perpendicular to the axis of the shaft hole 32 of the inner member 20. Therefore, the inner member 20 is reduced in size and weight, as compared with the constant velocity joint 10A according to the background art. The increased width of the trunnions 36a through 36c, as described above, allows the rigidity and strength of the trunnions 36a through 36c to be reliably maintained, and increases the range in which the trunnions 36a through 36c are movable.

With the constant velocity joint 10 according to the present embodiment, the trunnions 36a through 36c of the inner member 20 include the spherical surfaces 46a, 46b. Further, the centers RC of curvature of the spherical surfaces 46a, 46b are offset from the centers TC of the trunnions 36a through 36c, which are positioned on the central lines L1 that pass through the center A of the outer cup 16 and the centers of the guide grooves 22a through 22c. However, the present invention is not necessarily limited to such a structure.

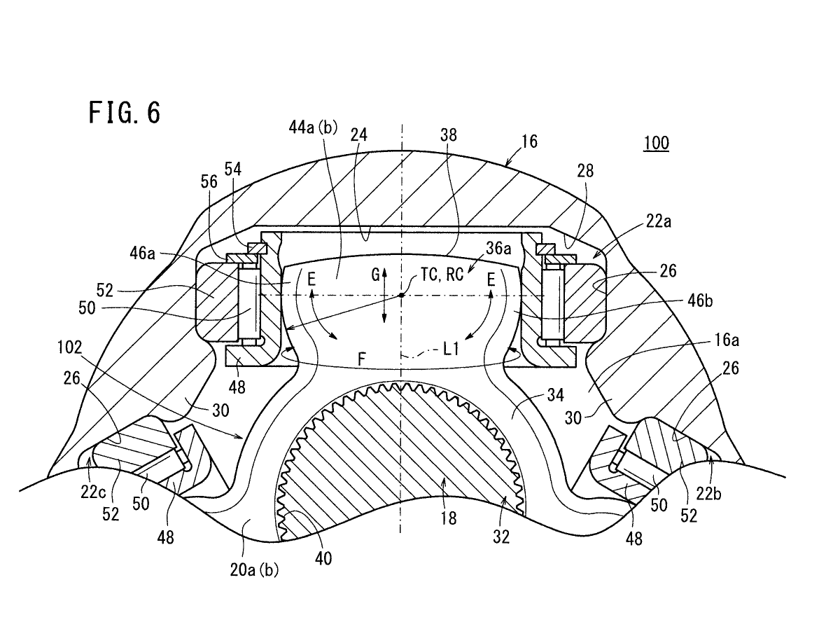

The present invention also is applicable to a constant velocity joint 100 as shown in FIG. 6. The constant velocity joint 100 has an inner member 102 in which the centers RC of curvature of the spherical surfaces 46a, 46b are aligned with the centers TC of the trunnions 36a through 36c, which are positioned on central lines L1 that pass through the center A of the outer cup 16 and centers of the guide grooves 22a through 22c.

The constant velocity joint according to the present invention is not limited to the above embodiment, but may adopt various alternative arrangements without departing from the scope of the invention as set forth in the appended claims.

1. A constant velocity joint comprising a tubular outer member, which has a plurality of guide grooves defined in an inner circumferential surface thereof, the guide grooves being spaced from each other and extending in an axial direction, the outer member being coupled to a first transmission shaft, and an inner member, which is inserted in the outer member and coupled to a second transmission shaft, wherein:
the guide grooves of the outer member have ceilings and rolling portions provided as flat surfaces substantially perpendicular to the ceilings, the rolling portions being held in abutment against rotors mounted on the inner member, the guide grooves being recessed radially outward with respect to the inner circumferential surface;
the inner member has a plurality of trunnions inserted respectively in the guide grooves, the rotors being rotatably mounted on respective outer circumferential surfaces of the trunnions; and
each of the trunnions has spherical surfaces that are arcuate in cross section, and which are fitted in a holder with one of the rotors being rotatably held thereon, and a set of flat surfaces lying perpendicular to an axial direction of a joint hole to which the second transmission shaft is coupled.

2. The constant velocity joint according to claim 1, wherein the inner member includes a ring member in which the second transmission shaft is fitted, and the trunnions project radially outward from the ring member toward the guide grooves, respectively.

3. The constant velocity joint according to claim 1, wherein the spherical surfaces have respective centers of curvature, which are offset from respective centers of the trunnions that are positioned on axial lines passing through the center of the outer member and respective centers of the guide grooves.

4. The constant velocity joint according to claim 2, wherein the spherical surfaces have respective centers of curvature, which are offset from respective centers of the trunnions that are positioned on axial lines passing through the center of the outer member and respective centers of the guide grooves.
